(19) United States
(12) Patent Application Publication
(10) Pub. No.: US 2021/0309161 A1
(43) Pub. Date: Oct. 7, 2021

(54) Universal blind spot detection system

(71) Applicant: Rydeen North America, Inc., Torrance, CA (US)

(72) Inventor: Philip Maeda, Torrance, CA (US)

(73) Assignee: Rydeen North America, Inc.

(21) Appl. No.: 15/732,628

(22) Filed: Dec. 5, 2017

(51) Int. Cl. B60R 11/04; B60D 1/64

(52) U.S. Cl. CPC B60R 11/04; B60R 2011/004; B60D 1/64

(57) ABSTRACT

A blind spot detection system mounted to the vehicle license plate frame in one embodiment and to a trailer hitch in a second embodiment.

### BACKGROUND OF THE INVENTION

### 1. Field of the Invention

The present invention relates to a vehicle safety system for the detection of vehicles and objects in the common blind spot of the drivers' vision.

### 2. Description of the Prior Art

A vehicle's blind spot is typically an area that is not in the drivers view and not covered by traditional mirrors in the vehicle. When changing lanes, an approaching vehicle from the rear at higher speeds or a vehicle at the same speed can often not be seen as the views offered by the traditional mirrors in the vehicle which are inadequate to cover these areas. They are often blocked by the frame or solid area of the approaching vehicle and do not have the coverage area needed to offer a safe view when changing lanes. Blind spot detection systems of many types have been developed to assist the driver in these situations offering a signal of some type when it is unsafe to make a lane change. Systems like these work very well when installed in a vehicle at the time of manufacture as optimal areas can be chosen for the mounting of such sensors that can be pre-determined when the vehicle is being designed.

Automotive blind spot section systems have been commercially available for some time. They are typically installed at the time of the vehicle manufacturing and are part of an overall safely system. For years the aftermarket has been trying to develop systems that can be added to existing vehicles to preform this task. Many types of systems have been developed but they all have limitations and preform poorly making these systems virtually useless in the prevention of accidents. If these systems are not working at 100% they are often ignored by the drivers as the information they provide is perceived as useless.

Some of these systems utilize ultrasonic-sensing techniques that require small ultrasonic sensors to be fitted in the rear and side of the vehicle. These sensors must be installed by drilling large holes in the rear side panels for the mounting of at least two sensors, one per side, at exact locations behind the rear wheels of the vehicle. These sensors use ultrasonic radio waves that transmit out only a few feet from the vehicle and they have several problems:
Ultrasonic sensors are adversely affected by wind that occurs while driving.
They are sensitive to rain and moisture that will cause them to not operate.
They can be covered by snow or mud in adverse driving conditions and will not operate
They require large holes to be cut in the vehicle that leaves the vehicle at risk of leaking and rust.
They must be color coded to the vehicle to match the finish that involves painting and color-matching of the sensors themselves.
They will not operate effectively when mounted in metal of any kind.
They have a very limited range typically 1-6 ft. that is not sufficient for this type of detection.

Radar or high frequency systems, called microwave and millimeter band that operate between 1 and 300 Gigahertz are the most accurate and do not suffer from the limitations of the ultrasonic based systems. These systems have been adopted as the standard type of systems for all original equipment manufacturers in the design of their vehicles. Their sensing range is far superior and offer cross traffic detection when leaving a parking space. These systems are not adversely affected by wind, rain, snow dirt or mud making then vastly better for an automotive use. These systems are generally install when building the vehicle and can be placed in a manner that will compliment their operation. Though these systems work very well when installed by the factory, they are often very hard or impossible to install after the car has been manufactured. They require removal of body panels and complex wiring in areas not available when the vehicle has already been put together. Radar systems are also limited as their signal can penetrate plastics of many kinds they cannot penetrate metal making them impossible to install in vehicles like work trucks or vans that often can benefit most from the installation of these systems. What is desired is a vehicle blind spot system that overcomes the obstacles noted hereinabove thus making them ideal for any vehicle including commercial vehicles that are equipped with metal panels and bumpers.

### SUMMARY OF THE INVENTION

The present invention focuses on vehicles that have not been manufactured with the OEM systems noted hereinabove but rather can be fitted to the vehicle after initial manufacturing has been completed. The system unitizes an advanced radio frequency system that accurately detects vehicles and objects within the blind spot that can be installed after the vehicle is manufactured in a way that is both effective and easy to install providing original equipment protection in a vehicle not equipped with the system from the factory. The system utilizes high frequency radio waves to detect vehicles or objects within the blind spot and is built in a way to minimize the time and expertize needed to install the system. This approach requires little knowledge to complete an integrate installation and can be used in any vehicle. By means of wireless transmission and simplified installation it can even be used as a do it yourself installation that would make the system ready available to all drivers and in so, making driving safer and potentially saving lives.

The present invention provides a high frequency or radar based system that is a self contained, all in one, system for accurate blind spot detection. The system has few major components that when operated together form an easy to install and accurate form of blind spot detection that can be used in any vehicle.

A first embodiment is designed for many conventional vehicles equipped with a standard license plate and frame or bar like assembly at the rear of the vehicle. The license plate frames location is one of the optimum locations for a high frequency radar based blind spot detection system. The license plate frame or bar structure is replaced with a prefabricated replacement frame that contains the necessary sensors and electronics required to complete the sensing portion of the system. The sensors are located at the absolute rear of the vehicle in a position that is not obstructed by any parts of the vehicle.

The first component of the system is a high frequency or radar based sensor configuration that is purposely built into a standard license plate frame or bar type structure. These are typically standard size making them universal in most cases or very adaptable to all vehicles. The system has but is not limited to, two sensors placed in a manner near in the center that provides the best coverage for blind spot detection. Since these sensors are already mounted and accurately placed they can be mounted very quickly by replacing the standard license plate frame. This offers many benefits as the sensors are already installed at the correct placement angle, they are prewired to a control interface within the mounting structure and avoid the potentially interfering body parts of the vehicle. The installation takes place by simply replacing the standard license plate frame with the purpose built replacement frame or bar. A control module within that structure will process the information received from the sensors by way of a specifically designed processor and the unit can transmit this information via hardwire or wirelessly to a second module located within the vehicle. This secure or open transmission or hardwired indicators will relay the information to the driver visually and/or audible information. The exterior control unit containing the sensors and processor can also house a camera that can aid in the reversing of the vehicle or provide useful information to the driver if needed. The images are also transmitted to a second controller within the vehicle in the same manner as the information from the sensors. This all in one exterior unit can be sealed and made water tight so it will be protected from the elements. The entire unit can be but is not limited to utilizing power, ground and other items needed for the connection by way of internal trunk wiring accessible within the area of the installation. In this manner the license plate frame or bar can be replaced and all of the connections necessary would likely be found in or around that location. These wires can also be connected in a traditional manner if needed by direct connection within the interior of the vehicle. This exterior plate module can be secured by means of security fasteners or screws that would prevent the theft of the exterior sensor unit. The wiring methodology is similar to that described in U.S. Pat. No. 9,434,316 issued on Sep. 6, 2016, the teachings of which are necessary for an understanding of the present invention being incorporated herein by reference.

A second embodiment of the invention is adapted for use with trucks and commercial vehicles that are equipped with a conventional tow hitch. These tow hitches are common on larger vehicles such as truck and work vehicles but can also be added to any vehicle for the towing of large or small items. With this arraignment, the sensors will be located at the absolute rear of the vehicle in a position that is not obstructed by any part of the vehicle.

The first component of the system is a high frequency or radar based sensor configuration that is purposely built on a male receptacle that will fit to an existing tow hitch. These are typically square and are of a standard size making them universal in most cases or very adaptable with small inserts or spacers. The system has but is not limited to, two sensors placed in a manner that provides the best coverage for blind spot detection. Since these sensors are already mounted and accurately placed they can be mounted very quickly by being inserted in the tow hitch receptacle. This offers many benefits as the sensors are already installed at the correct placement angle, they are prewired to a control interface within the mounting structure and they are beyond the potentially interfering body parts of the said vehicle. The installation would just be putting the prebuilt structure into the trailer receptacle. A control module within that structure will process the information received from the sensors by way of a specifically designed processor and the unit can transmit this information wirelessly to second module located within the vehicle. This secure or open transmission will relay the information to the driver by visual and/or audible means. The exterior control unit containing the sensors and processor can also house a camera that can aid in the reversing of the vehicle or provide useful information to the driver if needed. The images would also be transmitted to a second controller within the vehicle in the same manner as the information from the sensors. This all in one exterior unit can be sealed and made water tight so it will be protected from the elements. It can also be easily removed when traditional towing is required. The entire unit utilizes power, ground and other items needed for the connection by way of the trailer hitch plug wiring. In this way the unit can be inserted in the trailer hitch receptacle and the wiring needed could be supplied by the trailer hitch plug used for the lighting and other items needed for towing requiring no additional installation of any kind. These wires can also be configured in a traditional manner if needed by direct connection. In using the trailer hitch and trailer wiring the installation can be done in a short time period and can be removed quickly if needed for use in another vehicle. This exterior module can be secured by a traditional trailer lock that can be included or purchased separately for the vehicle.

The second controller that is common to both systems can be mounted in the interior of the vehicle and can act as a transceiver collecting the information from the license plate or trailer hitch mounted unit processing the information without the need for additional wiring from the rear of the vehicle. It will contain processors that deliver the information to the driver by any means necessary for the application desired. The information of vehicle presence detected by radar systems and cameras view can be displayed on TFT LCD monitor screen mounted on gooseneck shaped fixture or adhere to dashboard using double sided tape, or connection to monitor screen originally equipped in a vehicle can be accomplished via OEM interface hardwiring. The radar systems cover rearward blind spots of a vehicle and are positioned on both sides of the sensor (also at the front of a vehicle if necessary) to detect moving or stopping objects. The data transferring can be a traditional analog or digital connection, a data based delivery system or by way of radio frequency transmission such as but not limited to Bluetooth or Wi-Fi. The controller can be fashioned to connect directly to the vehicles OBDII data port that could provide working power, ground, Ignition ON power as well as other useful information such as but not limited to vehicle speed, engine and transmission state. By utilizing the OBDII connection, little or no additional wiring or installation is needed for the system to operate. The system could also use the data available within the OBDII connection to communicate to the vehicles body control module and both transmit and receive information through data from the vehicle directly. This information along with other sensors such as GPS can be used to limit operation of the system at very low speeds as well as retrieve information about turn indicator status or steering wheel position as well as all other available information on the central access network, (CAN System) of the vehicle.

Signaling in a visual or audible manner and can be configured to operate through the factory equipment of the vehicle, a stand-alone lighting and/or attenuator or to another device via radio frequency transmission such as but not limited to Bluetooth or Wi-Fi. This can be a user's portable device such as a phone, tablet computer or other device installed within the vehicle.

### DESCRIPTION OF THE DRAWINGS

For a better understanding of the present invention as well as other objects and further features thereof, reference is made to the following description which is to be read in conjunction with the accompanying drawing therein:

FIG. 1 is a block diagram of the basic analog/wired embodiment of the blind spot detection system of the present invention;

FIG. 2 is a block diagram of a second embodiment of the present invention wherein the blind spot detection system is incorporated in a trailer hitch;

FIG. 3 is a block diagram of a third embodiment of the present invention wherein the blind spot detection system is incorporated in the rear license plate frame or bar shaped structure of a vehicle;

FIG. 4A illustrates a conventional the trailer hitch and FIG. 4B illustrates the corresponding blind spot detection system described in FIG. 2; and

FIG. 5A illustrates a sensor bar positioned on a vehicle license plate frame used in conjunction with the blind spot detection system described in FIG. 3 secured and FIG. 5B illustrates a sensor bar having a hardwired camera.

### DESCRIPTION OF THE INVENTION

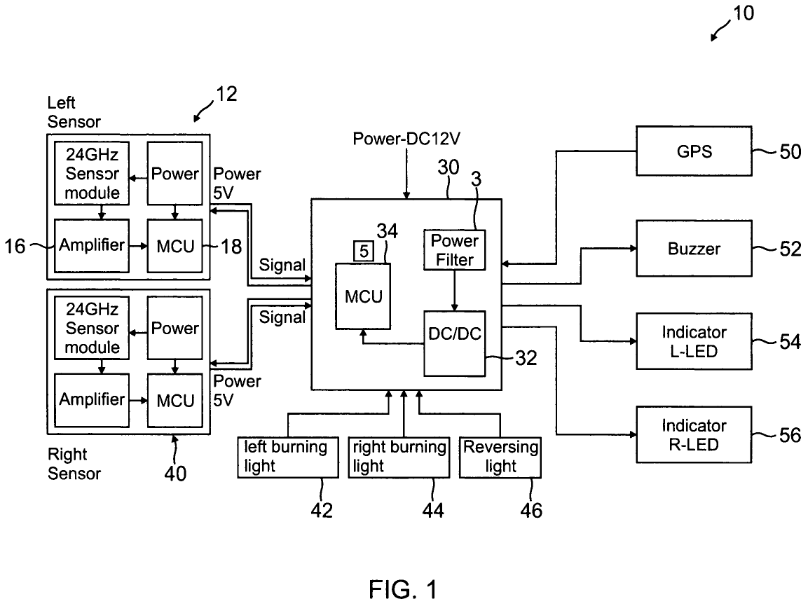

Referring to FIG. 1, a block diagram 10 of the blind spot detection system of the present invention is illustrated. The left sensor unit 12 transmits and receives high frequency signals and interprets the resulting data through a signal amplifier 16 and a microcontroller 18 to determine the presence of a physical object within the sensing area of the microwave sensor 12 (microcontroller unit 18 controls the frequency timing and amplitude of the sensing signal and processes the results from each sensor. Microcontroller 18 is preferably the RSP1 radar processor manufactured by RFbeam Microwave Gmbh, St. Gallen, Switzerland). The high frequency signal is sent and received and the frequency shift created by the object and the time of the signals reception determines the presence of an object or vehicle as well as its closing rate. Sensor unit 12 is activated at a speed that is predetermined to help negate false reading at slow speeds where many items could be sensed (as in a parking lot). The resulting data is sent to the main processor 30 that contains circuitry including, but not limited to, a filter to insure a clean power source, a voltage regulator 32 and the main processor module 34 (preferably a STM32F103 microprocessor manufactured by ST Microelectrics, Geneva, Switzerland).

The right sensor unit, 40 operates in the same manner as sensor 12 and delivers information to the main processor unit 30. These are identical modules that are focused on the right and left side, respectively, for turning or changing lanes in that direction.

The main processor module 30 also receives information from various other inputs that will help determine how and when the unit will signal the vehicle driver. Turn indicator inputs 42 and 44 are used to show the drivers intentions in changing lanes and making turns where blind spot sensing is most important. An input 46 for indicating when the vehicle is in the reverse gear is used to change the unit's operation mode for backing up and sensing cross traffic that could be hard to see while exiting parking spots, for example. In this mode, both sensors are active at their maximum sensing range and the data from GPS 50 would be overlooked (a GPS antenna accurately detects speed), as this would occur at speeds lower than the threshold for normal forward motion. These inputs also determine when an audible alert is necessary. For instance, while driving in a straight direction the system could be programmed to always provide a visual alert, such as an LED light, when an object or vehicle is in the blind spot to assist the driver. But if the driver operates a turn indicator indicating the desire to turn or switch lanes, a visual alert (LED's 54 and 56) and an audible alert are generated to indicate it is not safe and an object or vehicle may be in the driver's blind spot. In this scenario, the visual indication would always be ON while the system is active and the vehicle is in motion sensing an object in the blind spot. The added audible alert would activate when the driver indicates a desire to turn or change lanes. This final audible alert would happen regardless whether or not the driver sees the visual alert.

Processor unit 30 has other features that can be programmed by the user. Specifically, the user can adapt these settings for changing how the unit will operate depending on the type of vehicle and the desired results the specific user wishes to obtain. These programmable features can include but are not limited to:
The minimum speed at which the unit will operate (GPS50).
The duration of the visual alert signal (LED indicators 52 & 54) i.e. always on or only while the turn indicator is ON.
The audible attenuators actions (always on or only while the turn indicator is ON).
The volume and duration of the audible attenuator 52.
The sensing ranges of the high frequency microwave transceivers 12 and 40.

Processor unit 30 responds to the processed signals received and delivers indicators based on the predetermined setting that will alert the driver to objects or vehicles, in the driver's blind spot. The processor 30 is typically placed within the interior of the vehicle and can be connected to the ODBII data connection of the vehicle (ODBII refers to a vehicle's self-diagnostic and reporting capability) that would aid in the installation of the controller and enabling a do it yourself type of installation by the user. The controller can also be connected in an analog manner for a fixed installation if required.

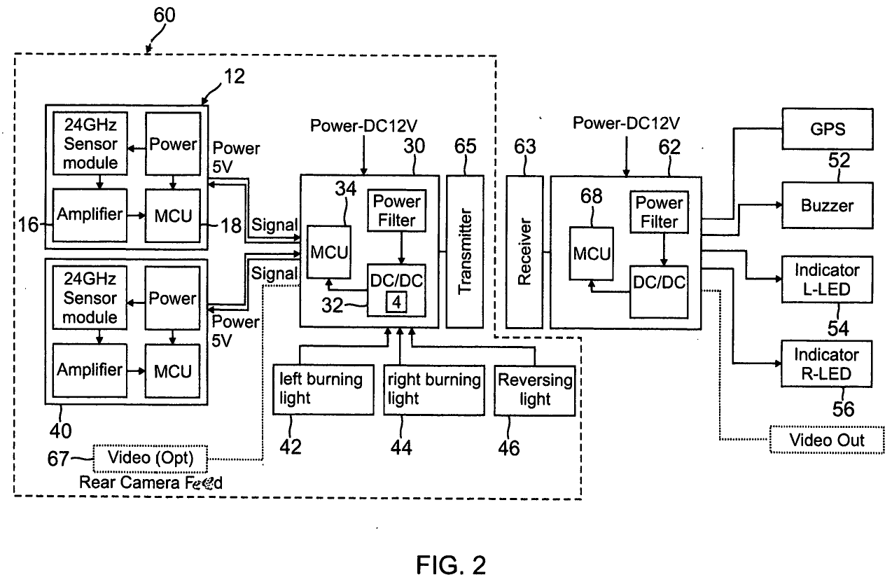

The configuration described in FIG. 2 shows how the data from a trailer hitch assembly 60 is wirelessly transmitted to the interior module 62 via receiver 63 that will process the information needed to alert the driver of objects within the blind spot. In this configuration, a video signal from transmitter 65 is transmitted to receiver 63 and used to assist in the blind side detection system function as well as combined to log data that can be integrated into video recorded from the rear video source 67. In this configuration assembly 60 can be easily removed and transferred between vehicles with minimal efforts.

The left microwave sensor unit 12 transmits and receives high frequency signals and interprets the resulting data through signal amplifier 16 and processor 18 to determine the presence of a physical object within the sensing area of microwave sensor 12. The high frequency signal is sent and received and the frequency shift created by the object and the time of the signals reception determines the presence of an object or vehicle as well as its closing rate. This sensor unit 12 is activated at a speed that is predetermined to help negate false reading at slow speeds where many items could be sensed such as in a parking lot. The resulting data is sent to the main processor 30 that contains circuitry including but not limited to a filter to insure a clean power source, a voltage regulator 32 and the main processor module 34 which contains a GPS receiver and logic predetermined for reliable operation.

The right sensor unit 40 operates in the same manner as sensor 12 delivers information to the main processor unit 30. These are identical modules that are focused on the right and left side, respectively for turning or changing lanes in that direction.

The processor module 30, also receives information from various other inputs that will help determine how and when the unit will signal the driver. Turn indicator inputs 42 and 44 are used to show the drivers intentions in changing lanes and making turns where blind spot sensing is most important. An input from the reverse gear of the vehicle 46 is also provided which is used to change the unit's operation mode for backing up and sensing cross traffic that could be hard to see, for example while exiting parking spots. In this mode both sensors would be active at their maximum sensing range and GPS data would be ignored, as this would occur at speeds lower than the threshold for normal forward motion. These inputs would also determine when an audible alert would be necessary. For instance, while driving in a straight direction the unit is programmed to provide a visual alert such as an LED light when an object or vehicle is in the blind spot to assist the driver. But if the driver turns on a turn indicator indicating the desire to turn or switch lanes, both a visual alert and an audible alert would be given to indicate it is not safe and an object or vehicle may be in the driver's blind spot. In this scenario the visual indication would always be ON while the system is active and the vehicle is in motion sensing an object in the blind spot. The added audible alert from buzzer 52 would activate when the driver indicates a desire to turn or change lanes. This final audible alert would happen regardless whether the driver sees the visual alert provided by LED indicators 54 and 56.

This processor unit 30 can also have features that can be programmed by the user. The user can adapt these settings for changing how the unit will operate depending on the type of vehicle and the desired results the specific user wishes to obtain. These programmable features can include but are not limited to:
The minimum speed at which the unit will operate.
The duration of the visual alert signal (50 always on or only on while the turn indicator is ON).
The audible attenuators actions (always on or only on while the turn indicator is ON).
The volume and duration of the audible attenuator.
The sensing ranges of the high frequency transceivers 12 and 40.

The processor, or MCU unit, 30 responds to the processed signals received and will deliver this information wirelessly to the interior processor, or MCU, 34 and its indicators based on the predetermined setting that will alert the driver to objects, vehicles, in the driver's blind spot. The processor 30 can be placed within the interior of the vehicle and is connected to the ODBII data connection of the vehicle that aids in the installation of the controller and enabling a DIY type of installation by the user. The controller can also be connected in an analog manner for a fixed installation (not on the license frame or trailer hitch) if required as shown in FIG. 1.

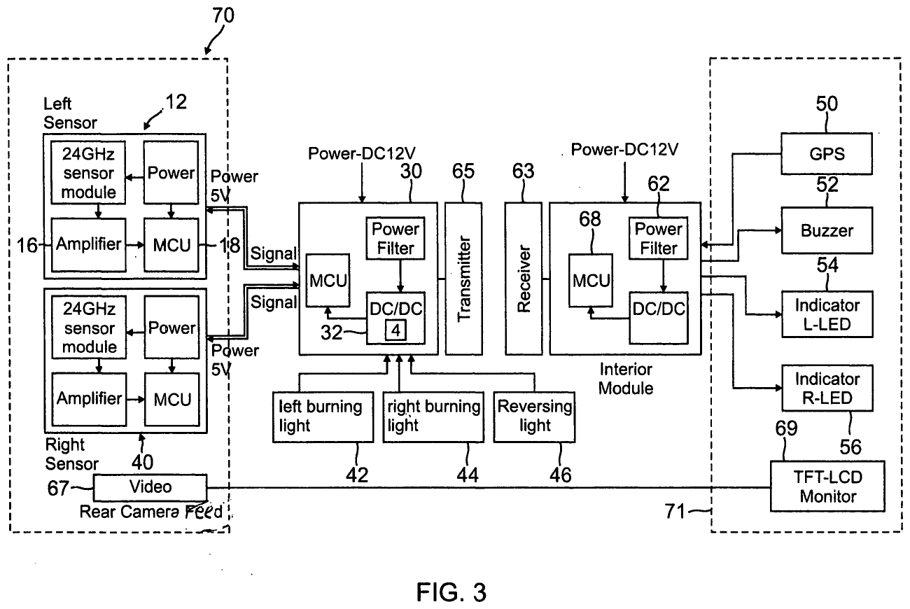

The configuration described in FIG. 3 shows how the data from the bar assembly 92 is processed, in dependent camera module 67 being connected to TFT/LCD monitor 69 within the vehicle interior, the license plate assembly 70 being hardwired to processor 30 or wirelessly by transmitter 65 to receiver 63 to the interior module 62, MCU 71 processing the information needed to alert the driver of objects within the blind spot. In this configuration, a video signal is also hardwire connected by camera 67 and used to assist in the blind spot detection system function as well as combined to log data that can be integrated into video recorded from the rear video source 67. In this configuration, the license plate assembly 70 can be easily removed and then installed on a different vehicle without removing the vehicle rear bumper of most vehicles which results in a lower cost of installation labor.

The left sensor unit 12 transmits and receives high frequency signals and interprets the resulting data through a signal amplifier 16 and a processor, or microcontrol unit MCU 18 to determine the presence of a physical object within the sensing area of the microwave sensor. The high frequency signal is sent and received and the frequency shift created by the object and the time of the signals reception determines the presence of an object or vehicle as well as its closing rate. This sensor unit is activated at a speed that is predetermined to help negate false readings at slow speeds where many items could be sensed such as in a parking lot. The resulting data is sent to the main processor 30 that contains circuitry including but not limited to a filter to insure a clean power source, a voltage regulator 32 and the main processor module 34 and logic predetermined for reliable operation.

The right sensor unit 40 operates in the same manner as the opposite side sensor 12 and will deliver information to the main processor unit 30. These are identical modules that are focused on the right and left side respectably for turning or changing lanes in that direction.

The processor module 30 also receives information various other inputs that will help determine how and when the unit will signal the driver. Turn indicator inputs from sensors 42 and 44 are used to show the drivers intentions in changing lanes and making turns where blind spot sensing is most important. There is also an input for the reverse gear of the vehicle from sensor 46 which will be used to change the unit's operation mode for backing up and sensing cross traffic that could be hard to see while exiting parking spots. In this mode both sensors would be active at their maximum sensing range and the GPS data would be overlooked, as this would occur at speeds lower than the threshold for normal forward motion. These inputs would also determine when an audible alert would be necessary. For instance, while driving in a straight direction the unit could be programmed to always alert with a visual alert such as an LED light when an object or vehicle is in the blind spot to assist the driver. But if the driver turns on a turn indicator indicating the desire to turn or switch lanes, both a visual alert would be given as well as an audible alert to indicate it is not safe and an object or vehicle may be in the driver's blind spot. In this scenario the visual indication would always be ON while the system is active and the vehicle is in motion sensing an object in the blind spot. The added audible alert would activate when the driver indicates a desire to turn of change lanes. This final audible alert would happen regardless of if the driver sees the visual alert.

This processor unit 30 has features that can be programmed by the user. The user can adapt these settings for changing how the unit will operate depending on the type of vehicle and the desired results the specific user wishes to obtain. These programmable features can include but are not limited to:
The minimum speed at which the unit will operate.
The duration of the visual alert signal. Always on or only on while the turn indicator is ON.
The audible attenuators actions (always on or only on while the turn indicator is ON).
The volume and duration of the audible attenuator.
The sensing ranges of the high frequency transceivers.

The processor unit 30 responds to the processed signals received and delivers this information via hardwires connected to various indicators 50, 52, 54 and 56 based on the predetermined setting that will alert the driver to objects and vehicles, in the driver's blind spot. The processor 30 can be placed within the interior of the vehicle and can be connected to the ODBII data connection of the vehicle that aids in the installation of the controller and enabling a do it yourself type of installation by the user. This controller can also be connected in an analog manner for a fixed installation if required.

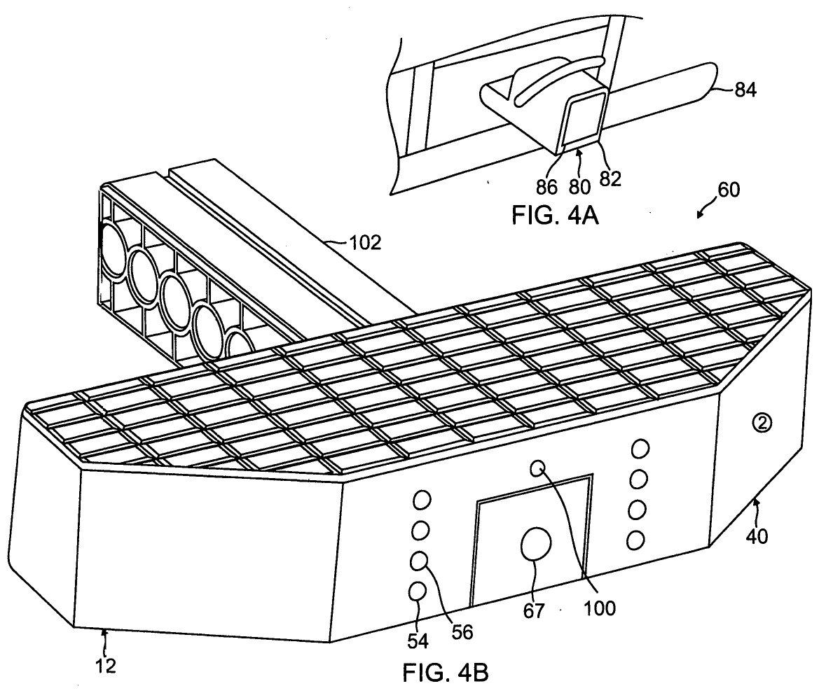

FIG. 4A illustrates a standard hitch 82 mounted to trailer 84 and trailer hitch assembly 60 is shown in FIG. 4B, assembly 60 being positioned within opening 86 of hitch 82 by inserting extension 102 therein and secured thereto with a lock (the various operating parameters of trailer hitch assembly 60 are set by a user). The perspective view of assembly 60 shows left radar sensor 12, right radar sensor 40, rear video camera 67, LED indicator lights 54 and 56 and photosensor 100 Note that the hitch could be used as a step for ease of entering or exiting the vehicle.

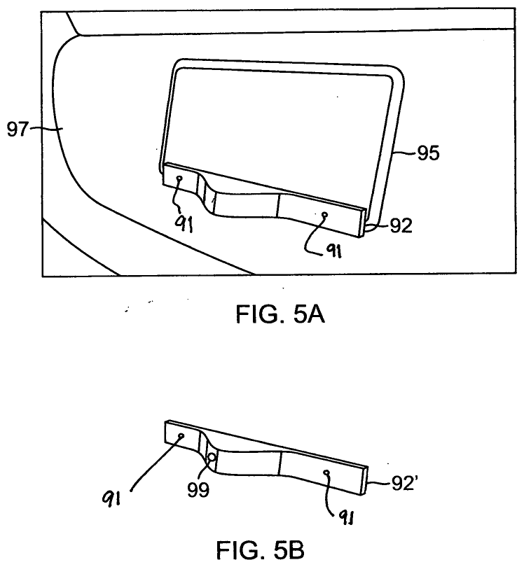

FIG. 5A illustrates plate bar 92 without a hardwired camera securely attached to the license plate 95 of vehicle 97 via screws 91, bar 92 incorporating the components of license plate assembly 70. Leads (not shown) for the power connection and ground from bar 92 are connected to the interior of the vehicle. FIG. 5B illustrates plate bar 92′, identical to bar 92 except for the addition of camera 99.

Processor 30 (FIG. 1) is located within the hitch and plate assemblies (FIGS. 4 and 5, respectively) on the exterior of the vehicles.

Unit 60 (FIG. 2) is positioned on the vehicle exteriors, all the circuitry being positioned in the interior of the vehicle (if an analog connection is desired, appropriate wiring is configured to replace receiver 63 and transmitter 65). The non-exterior circuitry is typically positioned under the vehicle dash board on the driver or passenger side for easy access.

The universality feature of the three blind side detection systems described above results from the fact that both versions, once attached to a particular vehicle, can be removed and used with a different vehicle.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A high frequency prefabricated vehicle blind spot detection system comprising sensors, a first processor and a wireless control module, the system being configured to be installed within a license plate frame or bar structure for the vehicle

2. The system of claim 1 wherein said system is connected to existing vehicle electrical devices, said connections enabling said system to operate.

3. The system of claim 1 further including for viewing the environment at the rear of said vehicle.

4. The system of claim 1 further including a second processor positioned within the said vehicle, said second processor receiving information transferred wirelessly from said first processor.

5. The system of claim 1 wherein said system is removable from said license plate frame.

6. A high frequency prefabricated vehicle blind spot detection system incorporated in a license plate frame comprising sensors, a first processor and a wireless control module that transmits processed information from the sensors to an interior control module and transceiver that is connected to a OBDII port in a first vehicle.

7. The system of claim 6 wherein the OBDII port detects vehicle speeds below a predetermined value and, in turn, limits system operation.

8. The system of claim 6 wherein said system is connected to a vehicle trailer hitch electrical connector to enable operation of said system.

9. The system of claim 6 further including a camera for aiding in the viewing the environment at the rear of said vehicle.

10. The system of claim 6 wherein said system is connected to a second processor within the said vehicle.

11. The system of claim 6 wherein said system is removable and adapted to be a second vehicle.

12. A high frequency prefabricated vehicle blind spot detection system comprising sensors, a processor and a wireless control module, said system being adapted to be installed in vehicle trailer hitch.

13. The system of claim 11 wherein said system is connected to the trailer hitch electrical connector to provide necessary connections for the operation of said system.

14. The system of claim 11 further including a camera for viewing the environment at the rear of said vehicle.

15. The system of claim 11 wherein retrieved information is transmitted by wireless means to a second processor within said vehicle.

16. The detection system of claim 1 further including a GPS device, the GPS device detecting vehicle speeds below a predetermined value and, as a result, limiting system operation.
